(19) United States
(12) Patent Application Publication
(10) Pub. No.: US 2026/0339826 A1
(43) Pub. Date: Oct. 29, 2026

(54) METHOD, DEVICE, AND MEDIUM FOR INTERACTION

(71) Applicants: Beijing Youzhuju Network Technology Co., Ltd., Beijing (CN); Lemon Inc., Grand Cayman (KY)

(72) Inventors: Xiao XIAO, Beijing (CN); Cole Wincent, Beijing (CN)

(21) Appl. No.: 19/191,802

(22) Filed: Apr. 28, 2025

(51) Int. Cl. G06F 11/3668; G06F 11/3698

(52) U.S. Cl. CPC G06F 11/3688; G06F 11/3698

(57) ABSTRACT

Embodiments of the present disclosure provide an interaction method, device, and medium for testing an application. The method comprises providing candidate change options for change the order status for the user. And the method comprises receiving the selected change option from the order status action area. And the method further comprises changing, based on the selected change option from the order status action area, the order status of the test order without verifying an actual status of the test order. And the method further comprises sending the changed order status of the test order to the user device to display the changed order status.

### BACKGROUND

After the developer service provider has developed the relevant application, it is necessary to test the application before publishing it. For example, after the developer service provider creates the application in the Shop Partner Center, it will be published in the Appstore for merchants to download and use. The application mainly involves the core scenarios of the e-commerce process such as goods and orders. Merchants can use the application to manage goods and orders more efficiently and conveniently. Before the application is put on the Appstore of the Seller Center, the developers need to ensure the availability of the application, so they need to conduct a series of tests on the application.

### SUMMARY

In a first aspect according to some embodiments of the present disclosure, an interaction method for testing an application is provided. The method comprises providing candidate change options for change the order status for the user. And the method comprises receiving the selected change option from the order status action area. And the method further comprises changing, based on the selected change option from the order status action area, the order status of the test order without verifying an actual status of the test order. And the method further comprises sending the changed order status of the test order to the user device to display the changed order status.

In a second aspect according to some embodiments of the present disclosure, an electronic device comprising a memory and a processor is provided. The memory is configured to store computer instructions which, when executed by the processor, cause the processor to obtain object information of a set of objects. The instructions further cause the processor to receive a test request to an application from a user device. In addition, the instructions further cause the processor to send a test page to the user device, wherein the test page is for the user to test the application, and the test page includes a test account area and a purchaser view area. In addition, the instructions further cause the processor to receive a first account request from the test account area. In addition, the instructions further cause the processor to create, based on the first account request, the first test account for the user with verifying an identification and a password of the user.

In a third aspect according to some embodiments of the present disclosure, a non-transitory computer-readable medium is provided. The medium comprises instructions stored thereon which, when executed by a processor, cause the processor to obtain object information of a set of objects. The instructions further cause the processor to receive a test request to an application from a user device. In addition, the instructions further cause the processor to send a test page to the user device, wherein the test page is for the user to test the application, and the test page includes a test account area and a purchaser view area. In addition, the instructions further cause the processor to receive a first account request from the test account area. In addition, the instructions further cause the processor to create, based on the first account request, the first test account for the user with verifying an identification and a password of the user.

Any of the one or more above aspects in combination with any other of the one or more aspects. Any of the one or more aspects as described herein. This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Embodiments of the present disclosure may be understood from the following Detailed Description when read with the accompanying figures. In accordance with the standard practice in the industry, various features are not drawn to scale. In fact, the dimensions of the various features may be arbitrarily increased or reduced for clarity of discussion. Some examples of the present disclosure are described with reference to the following figures.

FIG. 1 shows an application scenario in which one or more embodiments of the present disclosure may be implemented;

FIG. 2 is a flow chart illustrating an example interaction process 200 for test an application according to some embodiments of the present disclosure;

FIG. 3 shows a schematic diagram of a test page according to one or more embodiments of the present disclosure;

FIG. 4 shows a flow chart illustrating an example process of changing an order status of a test order according to one or more embodiments of the present disclosure;

FIG. 5 is a schematic diagram showing a seller view area according to one or more embodiments of the present disclosure;

FIG. 6 shows a flowchart of a method for changing an order shipping status of a test order according to one or more embodiments of the present disclosure;

FIG. 7 shows a schematic diagram of an exemplary test page according to one or more embodiments of the present disclosure;

FIG. 8 is a block diagram illustrating physical components (for example hardware) of an electronic device with which aspects of the present disclosure may be practiced.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the present disclosure. Aspects may be practiced as methods, systems or devices. Accordingly, aspects may take the form of a hardware implementation, an entirely software implementation, or an implementation combining software and hardware aspects. The following detailed description is therefore not to be taken in a limiting sense, and the scope of the present disclosure is defined by the appended claims and their equivalents. A plurality of steps recorded in method implementations in the present disclosure may be performed in different orders and/or in parallel. In addition, additional steps may be included and/or the execution of the illustrated steps may be omitted in the method implementations. The scope of the present disclosure is not limited in this aspect.

The term “including” used herein and variations thereof are an open-ended inclusion, namely, “including but not limited to”. The term “based on” is interpreted as “at least partially based on”. The term “an embodiment” means “at least one embodiment”; the term “another embodiment” means “at least one additional embodiment”; and the term “some embodiments” means “at least some embodiments”. The related definitions of other terms will be provided in the subsequent description. Concepts such as “first” and “second” mentioned in the present disclosure are only for distinguishing different apparatuses, modules, or units, and are not intended to limit the order or relation of interdependence of functions performed by these apparatuses, modules, or units. Variants of “one” and “a plurality of” mentioned in the present disclosure are illustrative and not restrictive, and those skilled in the art should understand that unless otherwise explicitly specified in the context, the modifiers should be understood as “one or more”. The names of messages or information exchanged between apparatuses in the implementations of the present disclosure are provided for illustrative purposes only, and are not used to limit the scope of these messages or information. Data (including the data itself, and data acquisition, or usage) involved in the technical solutions should comply with the requirements of corresponding laws and regulations, and relevant stipulations.

As mentioned above, before the application is put on the Appstore of the Seller Center, the developers need to ensure the availability of the application, so they need to conduct a series of tests on the application. The Seller Center usually refers to the backend system provided by an e-commerce platform for sellers to manage store operations. In the original plan, the developers needed to first apply for buyer-side and seller-side test accounts in the Development Shops of the Partner Center, and the Partner Center is usually designed around partnership management, aiming to provide a central platform for collaboration, management, and resource sharing between the platform and partners to achieve mutual benefit and win-win results. And then the developers needed to simulate buyers and sellers in client application and Seller Center to place and manage product orders to ensure the availability of the application during the entire order flow process. That is, the developers need to operate across multiple platforms (Partner Center/Seller Center/user device) and multiple devices (PC & Mobile), and the process is lengthy, cumbersome, time-consuming and labor-intensive. Another problem of the original plan is that the developers need to provide real information (e.g., bank card number, tax information, etc.) to complete the test account entry review. In practice, the developers are unwilling to provide such kind of real information.

Therefore, it can be seen that a method or system is needed to solve at least one of the above multiple problems. The present disclosure proposes an interaction method, device, system, medium, etc. for testing an application. Exemplarily, the embodiments of the present disclosure provide an interactive split-screen layout within a page to present multi-perspective operations, reduce cross-platform and device jumps, or independently handle test account logic without the need for real data.

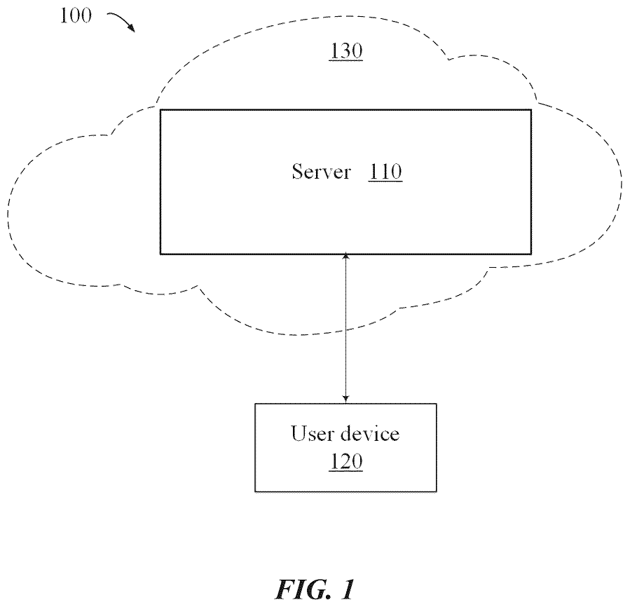

FIG. 1 shows an application scenario 100 in which one or more embodiments of the present disclosure may be implemented. In the scenario 100, in some embodiments, a user device 120 may interact with a server 110 for testing an application. The user device 120 may be a personal computer, a smart phone, a laptop etc., or the user device 120 may be another server. It is worth noting that one or more embodiments of the present disclosure do not impose any restrictions on the type of user device. Any user device suitable for the present disclosure should be within the scope of protection of the present disclosure. In some embodiments, the server 110 may act as a Partner Center. In some embodiments, the server 110 may be located in a cloud 130. In some embodiments, the server 110 may exchange information with the user device 120 for testing the application.

Next, multiple embodiments of the present disclosure will be described in detail with reference to the relevant drawings and based on the scenario 100 according to one or more embodiments of the present disclosure.

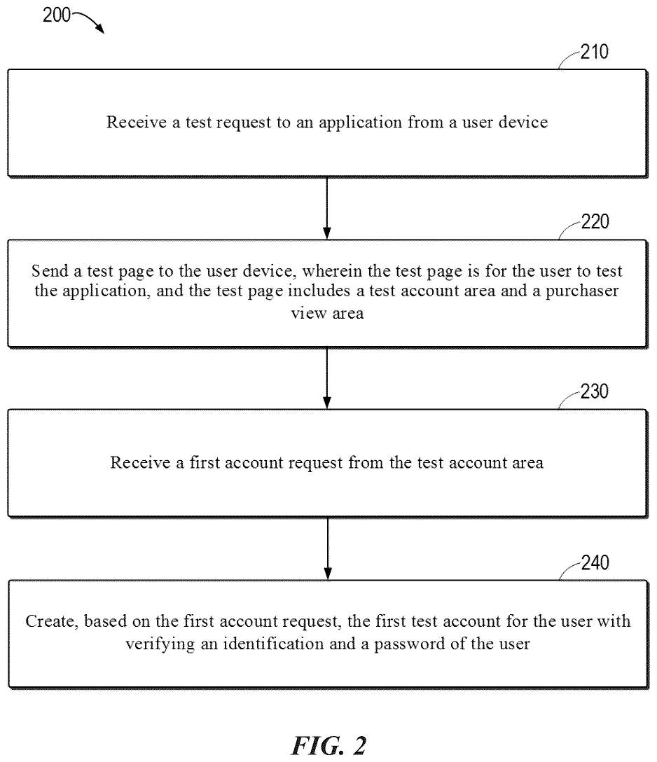

FIG. 2 is a flow chart illustrating an example interaction process 200 for test an application according to some embodiments of the present disclosure. The example interaction process 200 may be implemented by a computing device, and may be implemented in the scenario 100. The present disclosure does not specifically limit the specific implement of the process 200. Any suitable implement of process 200 for the present disclosure should be within the protection scope of the present disclosure. As shown in FIG. 2, at block 210, a test request to an application is received from a user device. In some embodiments, the user device 120 may send a test request to the server 110, the server 110 may be a Partner Center. In some embodiments, the server 110 may receive the test request to an application and analyze the request, and in response to the request, the server 110 may decide to provide test related service for the user device 120 if the user is a qualified user.

At block 220, a test page is sent to the user device, wherein a test page is for the user to test the application, and the test page includes a test account area and a purchaser view area. In some embodiment, the test page may be created in the server 110, and then the test page may be sent to the user device 120 and may be displayed on the display of the user device 120. In some embodiment, the test page may include a test account area and a purchaser view area. In some embodiments, the purchaser view area includes a creating test order area, and the creating test order area is used to create one or more test orders for a selected test account of the user.

At block 230, a first account request is received from the test account area. In some embodiments, the user may initiate the first account request to create a first test account from the test account area in the test page from the user device 120. In some embodiments, the first account request to create a first test account from the test account area may be sent to the server 110 from the user device 120. In some embodiments, a second account request may be received from the test account area in the test page from the user device 120. In some embodiments, the second account request from the test account area may be sent to the server 110 from the user device 120.

At block 240, based on the first account request, the first test account is created for the user with verifying an identification and a password of the user. In some embodiments, the process 200 only need to check identification and a password of the user, and the process 200 doesn't need to check other information (e.g., bank card number, tax information, etc.). It is worth noting that the identification and the password of the user is not the identification and the password for the test account, and using the the test account per se doesn't use any identification and the password. The identification and the password of the user is used to permit the user to use the application test service, for example, to submit a request of creating the test page. In this way, the process 200 can independently handle test account logic without the need for real data, and it can bring very good user experience.

In some embodiments, the process 200 may further comprise receiving a second account request to create a second test account from the test account area. In some embodiments, the process 200 may further comprise creating, based on the second account request to create a second test account from the test account area, the second test account for the user. In some embodiments, the process 200 may further comprise receiving a request to switch to a test account from the test account area. And in some embodiments, the process 200 may further comprise switching to the requested test account of the user, wherein the requested test account of the user includes the first test account of the user or the second test account of the user. In this way, the user can own more than one test account, and the user can test more than one application based on the more than one test account, and the user can switch the test of the more than one application based on the more than one test account. In this way, the process 200 can bring very good user experience to the user.

In some embodiments, the process 200 may further comprise receiving a request to create a test order from the creating test order area. In some embodiments, the process 200 may further comprise creating the test order for the user. And in some embodiments, the process 200 may further comprise sending the information of the test order to the user device to display information of the test order. In this way, the user can test the application within the same page with the test account area from the purchaser view area. And the user doesn't need to jump from the test account area in one page on one device to the purchaser view area in another page on another device. Thus, the process 200 can bring very good user experience to the user.

In some embodiments, the purchaser view area may further include an order status action area, and the order status action area is used to change the order status of the test order by the user. In some embodiments, the process 200 may further comprise receiving a request to change the order status of the test order from the order status action area. In some embodiments, the process 200 may further comprise changing, based on the request to change the order status of the test order from the order status action area, the order status of the test order. In some embodiments, based on JavaScript (JS) and Cascading Style Sheets (CSS), the test account area and the purchaser view area can be developed. In this way, by adding the function of quickly changing the test order status, the process 200 can avoid real logistics and payment links, and simulate the order flow. Thus, the process 200 can bring very good user experience to the user.

In this way, the process 200 provides a test page with the test account area and the purchaser view area for testing applications, the user can create more than one test account without verifying other specific qualifications, and the user can test the applications within one test page and don't need to jump among different pages and devices. And the user also can avoid real logistics and payment links, and simulate the order flow. Thus, the process 200 can bring very good user experience to the user.

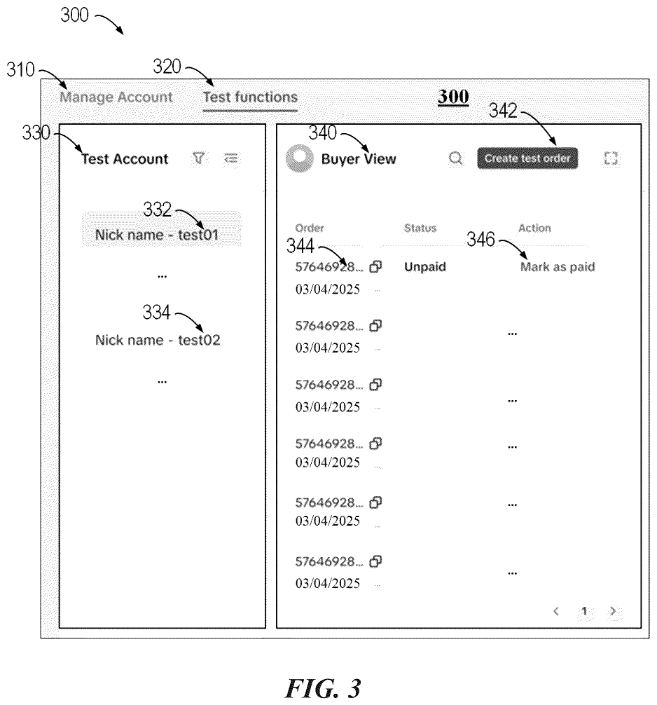

FIG. 3 shows a schematic diagram of a test page 300 according to one or more embodiments of the present disclosure. In some embodiments, the test page 300 includes the functions of manage account 310 and the test functions 320. The manage account 310 corresponds to an area of test account 330. In the area of test account 330, two test accounts 332 and 334 have been created without verifying other specific qualifications. In some embodiments, the user may only use his/her identification and password to create the two test accounts 332 and 334. In this way, the user can create more than one test account without verifying other specific qualifications, and the user can test the applications within one test page and don't need to jump among different pages and devices.

In some embodiments, the test page 300 may include an area of buyer view 340. In some embodiments, the user may create at least one test order 344 at 342 to test applications. The test orders 344 have attributions of status and action. In some embodiments, the user may change the order status of the test order 344, based on the request to change the order status of the test order 344 from the order status action area, as shown at 346. In this way, the user can avoid real logistics and payment links, and simulate the order flow.

Generally, traditional testing methods require the construction of a complete e-commerce environment, which has many defects. One defect is that testing order status changes depends on real logistics/payment systems, resulting in a long testing cycle. And another defect is that the test account needs to complete the full real-name authentication process, increasing the complexity of the test. On the other hand, it is impossible to observe the interaction status changes of the buyer and seller views in real time. One or more embodiments of the present disclosure are aimed to solve one or more of the defects.

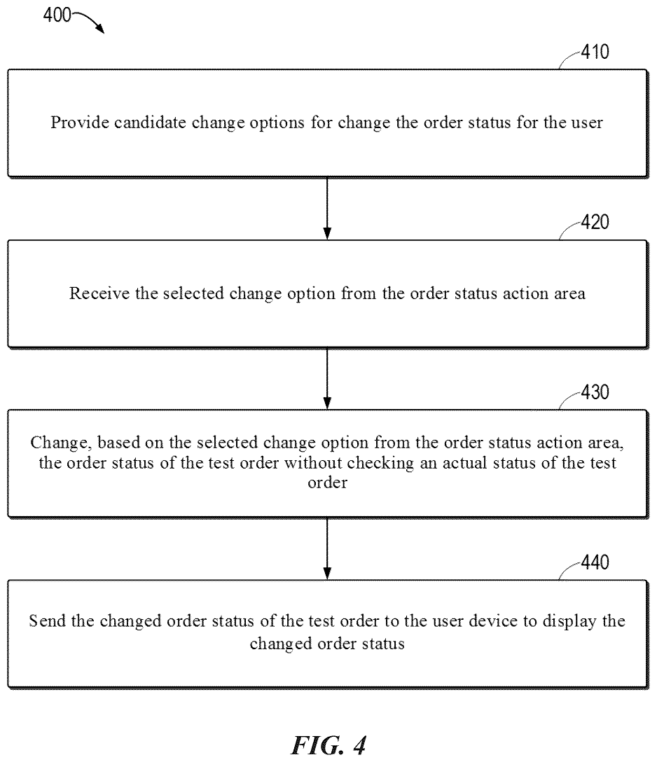

Furthermore, FIG. 4 shows a flow chart illustrating an example process 400 of changing an order status of a test order according to one or more embodiments of the present disclosure. At 410, candidate changing options are provided for change the order status for the user. In some embodiments, as shown in FIG. 3, the candidate changing options of “Mark as paid”, “Cancel order”, and “Request refund” etc. have been provided for the user to choose. In some embodiments. the user may decide to click the options to change the status of the test order. In some embodiments, the options may be sent to the user device together with the test page and display on the user device.

At 420, the selected change option is received from the order status action area. In some embodiments, the server may receive the selected change option from the order status action area from the user device. In some embodiments, the status operation area may includes a virtual logistics control panel, a virtual payment control panel and an abnormal status injection module. The virtual logistics control panel may include forced delivery or delayed delivery options, and the virtual payment control panel may include payment success or payment failure options, and the abnormal status injection module may simulate abnormal scenarios such as network interruption, payment timeout, etc. At 430, based on the selected change option from the order status action area, the order status of the test order is changed, without verifying an actual status of the test order. In some embodiments, the server may change, based on the selected change option from the order status action area, the order status of the test order, without verifying an actual status of the test order.

Then at 440, the changed order status of the test order is sent to the user device to display the changed order status. In some embodiments, the server may send the changed order status of the test order to the user device to display the changed order status. In some embodiments, the user device may receive the changed order status of the test order and display the changed order status in the test page. For example, when the user device may change the status of the test order 344 to be “Paid”, once the user device receives the changed status which is changed by the action of “Mark as paid” in the action area. In this way, the process 400 can change the order status, but avoid real logistics and payment links, and simulate the order flow.

In some embodiments, the test page may further include a seller view area, and the seller view area includes a shipping management area, and the shipping management area is at least used to change a shipping status of a test order. In some embodiments, a request to change the shipping status of the test order may be received from the shipping management area. In some embodiments, based on the request to change the shipping status of the test order from the shipping management area, the shipping status of the test order may be changed.

In some embodiments, the test account area may include a test account displaying area, and the purchaser view area may further include an order display area, and the order display area is for displaying information of one or more test orders of a selected test account of the user, and the information of the one or more test orders includes at least one of an order number and an order status. In some embodiments, the seller view area includes a shipping status displaying area, and the shipping status display area is for displaying shipping information of one or more test orders of a selected test account of the user, and the shipping information of the one or more test orders includes at least one of an order number and a shipping status.

In some embodiments, the test account area, the purchaser view area and the seller view area may interact based on one or more test accounts. In some embodiments, the test account area, the purchaser view area and the seller view area may be all on the same page of the test page. In some embodiments, the sizes of the test account area, the purchaser view area and the seller view area may be dynamically adjustable by the user. In some embodiments, the test account area and the purchaser view area may be developed based on JavaScript (JS) and Cascading Style Sheets (CSS), and the seller view area may be developed based on at least one of iframe, widget and dynokit, wherein a seller center core may be inserted into the seller view area.

In some embodiments, the server may send the created test account to the user device to display the created test account in the test account displaying area of the test account area. In some embodiments, the server may send the information of one or more test orders of a selected test account of the user to the user device to display information of one or more test orders in the order display area of the seller view area. In some embodiments, the server may send the shipping information of one or more test orders of a selected test account of the user to the user device to display the shipping information of one or more test orders in the shipping status display area of the seller view area.

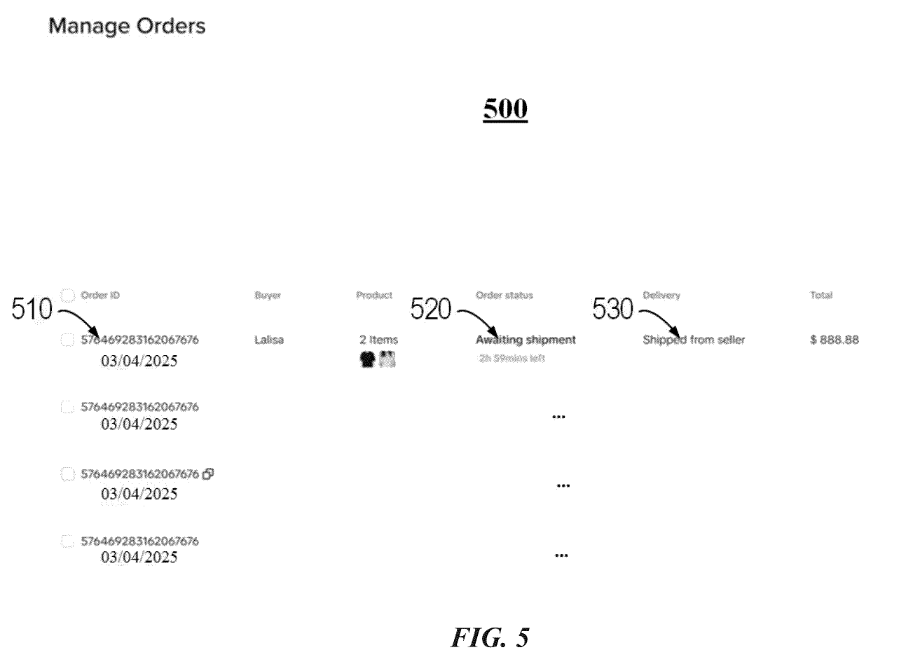

FIG. 5 is a schematic diagram showing a seller view area 500 according to one or more embodiments of the present disclosure. In some embodiments, the seller view area 500 may be developed based on at least one of iframe, widget and dynokit, wherein a seller center core may be inserted into the seller view area. In some embodiments, the seller view area 500 may be combined into the test page together with the test account area and the purchaser view area. As shown in FIG. 5, the seller view area 500 may include the orders 510s, the shipping statuses of the orders 520 and the shipping management area 530. In some embodiments, the user may change the shipping statuses of the orders 520 through the shipping management area 530. In some embodiments, for example, the user may select “shipped from the seller” at 530 to change the shipping status of “Awaiting shipment” of 520 to be “shipped”. In this way, the user can change the order status, but avoid real logistics, and simulate the order flow.

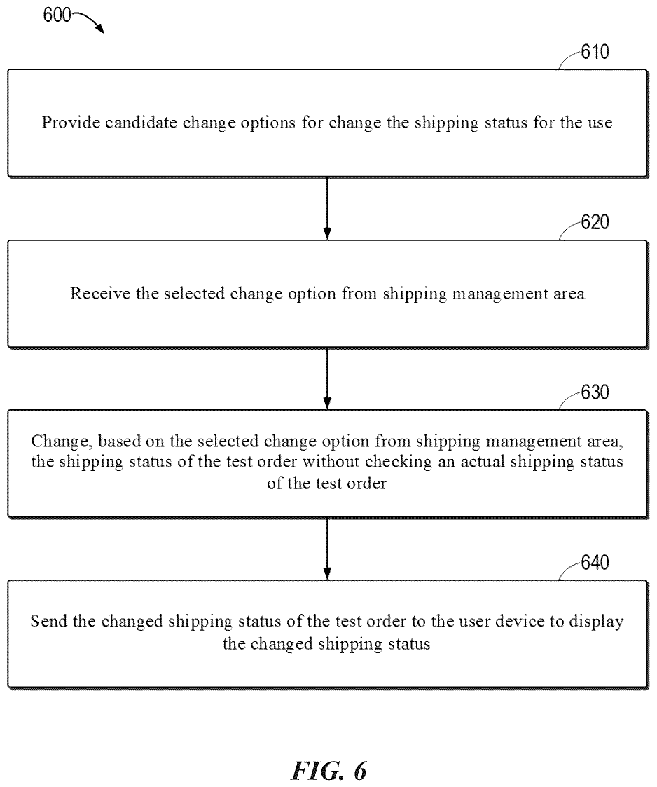

Furthermore, in some embodiments, based on the request to change the shipping status of the test order from the shipping management area, the shipping status of the test order may be changed. FIG. 6 shows a flowchart of a method 600 for changing an order shipping status of a test order according to one or more embodiments of the present disclosure. At 610, candidate change options for change the shipping status are provided for the user. In some embodiments, the server may provide candidate change options for change the shipping status for the user. In some embodiments, the user may decide whether to change the shipping status of the test order. At 620, the selected change option from shipping management area is received. In some embodiments, the server may receive the selected change option from the shipping management area of the test page on the user device.

Furthermore, at 630, based on the selected change option from the shipping management area, the shipping status of the test order is changed without verifying an actual shipping status of the test order. In some embodiments, the server may change, based on the selected change option from shipping management area, the shipping status of the test order without verifying an actual shipping status of the test order. In this way, the user can change the order status, but avoid real logistics, and simulate the order flow. Then at 640, the changed shipping status of the test order to the user device is sent to display the changed shipping status. In some embodiments, the server may send the changed shipping status of the test order to the user device to display the changed shipping status on the user device. In some embodiments, the user device may display the changed shipping status in the shipping management area of the test page on the user device.

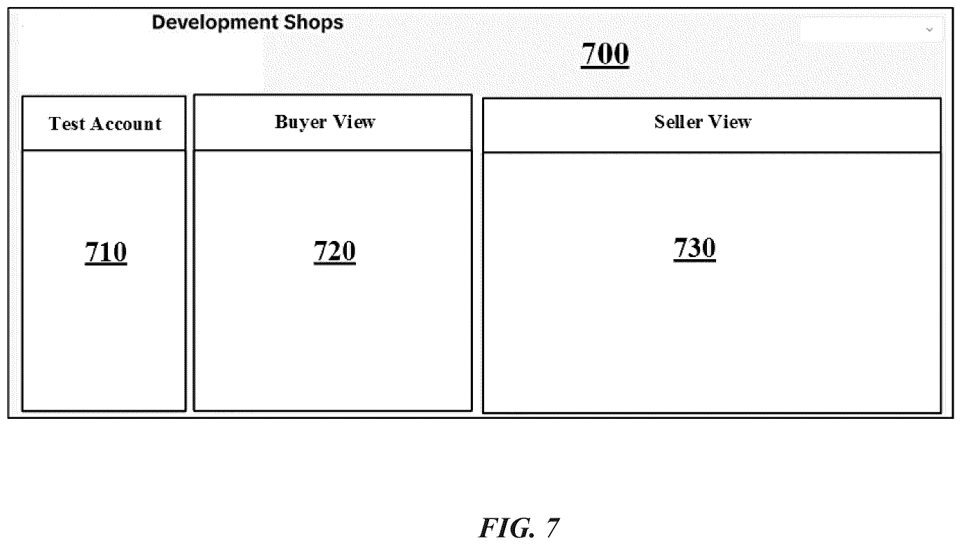

In order to help those skilled in the art better understand one or more embodiments of the present disclosure as a whole, FIG. 7 shows a schematic diagram of an exemplary test page 700 according to one or more embodiments of the present disclosure. In some embodiments, the test page 700 includes the test account area 710, the purchaser view area 720 and the seller view area 730, and the test account area 710, the purchaser view area 720 and the seller view area 730 are all located on the same page of the test page 700. In some embodiments, the sizes of the test account area 710, the purchaser view area 720 and the seller view area 730 are dynamically adjustable by the user. In some embodiments, the test account area 710 and the purchaser view area 720 may be developed based on JS and CSS, and the seller view area 730 may be developed based on at least one of iframe, widget and dynokit, where a seller center core is inserted into the seller view area 730 to implement the functions of the seller view area 730.

In some embodiments, the server may receive a test request to an application from a user device, and the server may send a test page 700 to the user device, wherein the test page 700 is for the user to test the application, and the test page 700 includes the test account area 710 and the purchaser view area 720. And the server may receive a first account request to create a first test account from the test account area 710. And then, the server may create, based on the first account request, the first test account for the user with verifying an identification and a password of the user. Furthermore, the server may further receive a second account request to create a second test account from the test account area 710, and the server may further create, based on the second account request to create a second test account from the test account area 710, the second test account for the user. Furthermore, the server may further receive a request to switch to a test account from the test account area 710, and the server may further switch to the requested test account of the user, wherein the requested test account of the user includes the first test account of the user or the second test account of the user. In some embodiments, the test account area 710, the purchaser view area 720 and the seller view area 730 may interact based on one or more test accounts. In this way, the user can own more than one test account, and the user can test more than one application based on the more than one test account, and the user can switch the test of the more than one application based on the more than one test account. Thus, it can bring very good user experience to the user.

In some embodiments, the purchaser view area 720 may include a creating test order area, and the creating test order area is used to create one or more test orders for a selected test account of the user. In some embodiments, the server may receive a request to create a test order from the creating test order area, and the server may further create the test order for the user, and the server may further send the information of the test order to the user device to display information of the test order. In some embodiments, the purchaser view area 720 may further includes an order status action area, and the order status action area is used to change the order status of the test order by the user. In some embodiments, the server may receive a request to change the order status of the test order from the order status action area, and the server may further change, based on the request to change the order status of the test order from the order status action area, the order status of the test order. Furthermore, the server may provide candidate change options for change the order status for the user, and the server may further receive the selected change option from the order status action area, and the server may further change, based on the selected change option from the order status action area, the order status of the test order without verifying an actual status of the test order, and the server may further send the changed order status of the test order to the user device to display the changed order status. In this way, by quickly changing the test order status, it can avoid real logistics and payment links, and simulate the order flow. Thus, it can bring very good user experience to the user.

In some embodiments, the seller view area 730 may include a shipping management area, and the shipping management area is at least used to change a shipping status of a test order. In some embodiments, the server may receive a request to change the shipping status of the test order from the shipping management area, and the server may further change, based on the request to change the shipping status of the test order from the shipping management area, the shipping status of the test order. Furthermore, the server may provide candidate change options for change the shipping status for the user, and the server may further receive the selected change option from shipping management area, and the server may further change, based on the selected change option from shipping management area, the shipping status of the test order without verifying an actual shipping status of the test order, and the server may further send the changed shipping status of the test order to the user device to display the changed shipping status. In this way, the user can change the order status of shipment, but avoid real logistics, and simulate the order flow. Thus, it can bring very good user experience to the user.

In some embodiments, the test account area 710 may include a test account displaying area, and the purchaser view area 720 may further include an order display area, and the order display area is for displaying information of one or more test orders of a selected test account of the user, and the information of the one or more test orders includes at least one of an order number and an order status. Furthermore, the seller view area 730 may include a shipping status displaying area, and the shipping status display area is for displaying shipping information of one or more test orders of a selected test account of the user, and the shipping information of the one or more test orders includes at least one of an order number and a shipping status. In some embodiments, the server may send the created test account to the user device to display the created test account in the test account displaying area of the test account area 710, or the server may further send the information of one or more test orders of a selected test account of the user to the user device to display information of one or more test orders in the order display area of the seller view area 730, or the server may further send the shipping information of one or more test orders of a selected test account of the user to the user device to display the shipping information of one or more test orders in the shipping status display area of the seller view area 730.

In some embodiments, the test page 700 may include a test account quick creation portal. And the test account quick creation portal may be used to create the test account quickly. In some embodiments, the test page 700 may include an order status sandbox control panel. And the order status sandbox control panel may be used to sandbox control the order status. In some embodiments, the test page 700 may include buyer and seller view comparison display area. And the buyer and seller view comparison display area may be used to display the buyer and seller view comparison. In some embodiments, the test page 700 may include an abnormal status injection shortcut button. And the abnormal status injection shortcut button may be used to inject abnormal status for the orders.

In this way, by leveraging the exemplary test page 700, one or more embodiments of the present disclosure provide a method, electronic device, system and medium thereof for solving a new interactive method for developers and service providers to test the availability of Apps in order flow scenarios. One or more embodiments of the present disclosure adopt a one-screen compatible with multiple perspectives and multiple processes, and by placing the buyer's order process and the seller's order process of two different platforms on the same page, the developer's jump across platforms and devices is reduced, making the test process more coherent and efficient. In addition, one or more embodiments of the present disclosure also support flexible layout, and by supporting manual adjustment of the layout width of each area, the main test goals of users in different test scenarios are met. In addition, one or more embodiments of the present disclosure further provide a fast simulation of the order process, by adding the function of quickly changing the test order status, avoiding the real logistics and payment links, and simulating the real scene to fully test all the flows of forward and reverse orders. Therefore, one or more embodiments of the present disclosure provide a new interactive method for solving the problem of developers and service providers testing the availability of Apps in order flow scenarios, which brings a particularly good user experience to developer users.

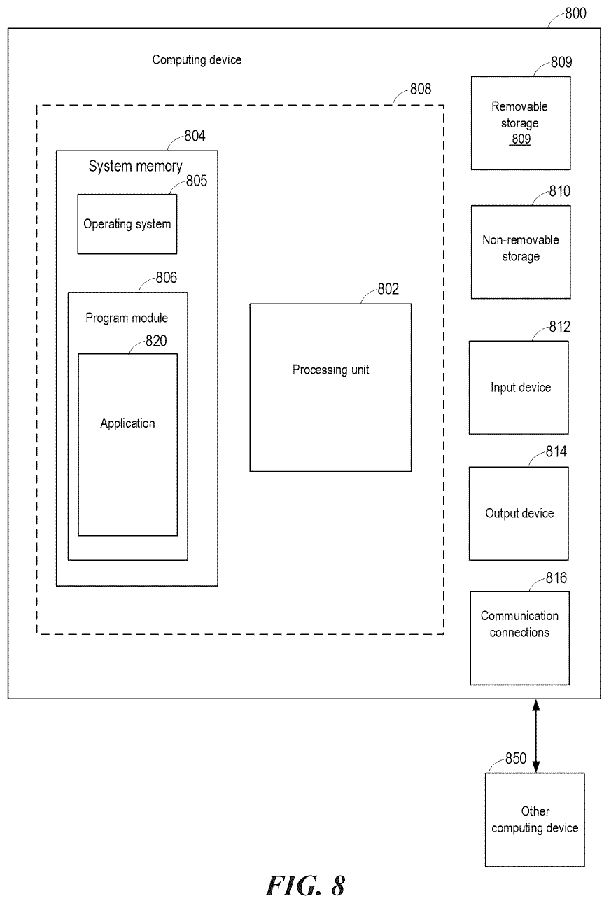

FIG. 8 is a block diagram illustrating physical components (e.g., hardware) of an electronic device 800 with which aspects of the disclosure may be practiced. For example, the electronic device 800 may implements the processes as depicted in FIGS. 2, 4 and 6. In a basic configuration, the processing device 800 may include at least one processing unit 802 and a system memory 804. Depending on the configuration and type of computing device, the system memory 804 may comprise, but is not limited to, volatile storage (e.g., random access memory), non-volatile storage (e.g., read-only memory), flash memory, or any combination of such memories.

The system memory 804 may include an operating system 805 and one or more program modules 806 suitable for performing the various aspects disclosed herein such. The operating system 805, for example, may be suitable for controlling the operation of the processing device 800. Furthermore, aspects of the disclosure may be practiced in conjunction with other operating systems, or any other application program and is not limited to any particular application or system. This basic configuration is illustrated in FIG. 8 by those components within a dashed line 808. The processing device 800 may have additional features or functionality. For example, the processing device 800 may also include additional data storage devices (removable and/or non-removable) such as, for example, magnetic disks, optical disks, or tape. Such additional storage is illustrated in FIG. 8 by a removable storage device 809 and a non-removable storage device 810.

As stated above, several program modules and data files may be stored in the system memory 804. While executing on the at least one processing unit 802, an application 820 or program modules 806 may perform processes including, but not limited to, one or more aspects, as described herein. The application 820 may include an application interface 821 which may be the same as or similar to the application interface 821 as previously described in more detail with regard to FIG. s 3, 5-9. Other program modules that may be used in accordance with aspects of the present disclosure may include electronic mail and contacts applications, word processing applications, spreadsheet applications, database applications, slide presentation applications, drawing or computer-aided application programs, etc., and/or one or more components supported by the systems described herein.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the processing device 500 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general-purpose computer or in any other circuits or systems.

The processing device 800 may also have one or more input device(s) 812 such as a keyboard, a mouse, a pen, a sound or voice input device, a touch or swipe input device, etc. The output device(s) 814 such as a display, speakers, a printer, etc. may also be included. The aforementioned devices are examples and others may be used. The processing device 500 may include one or more communication connections allowing communications with other computing or processing devices 850. Examples of suitable communication connections include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 904, the removable storage device 809, and the non-removable storage device 810 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the processing device 800. Any such computer storage media may be part of the processing device 800. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Any of the steps, functions, and operations discussed herein can be performed continuously and automatically.

The exemplary systems and methods of this disclosure have been described in relation to computing devices. However, to avoid unnecessarily obscuring the present disclosure, the preceding description omits several known structures and devices. This omission is not to be construed as a limitation. Specific details are set forth to provide an understanding of the present disclosure. It should, however, be appreciated that the present disclosure may be practiced in a variety of ways beyond the specific detail set forth herein.

Furthermore, while the exemplary aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed configurations and aspects.

Several variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a non-transitory storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

The disclosure is not limited to standards and protocols if described. Other similar standards and protocols not mentioned herein are in existence and are included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various configurations and aspects, includes components, methods, processes, systems and/or apparatus substantially as depicted and described herein, including various combinations, sub-combinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A method, comprising:
receiving a test request to an application from a user device;
sending a test page to the user device, wherein the test page is for the user to test the application, and the test page includes a test account area and a purchaser view area;
receiving a first account request from the test account area; and
creating, based on the first account request, the first test account for the user with verifying an identification and a password of the user.

2. The method according to claim 1, the method further comprising:
receiving a second account request from the test account area; and
creating, based on the second account request to create a second test account from the test account area, the second test account for the user.

3. The method according to claim 2, the method further comprising:
receiving a request to switch to a test account from the test account area; and
switching to the requested test account of the user, wherein the requested test account of the user includes the first test account of the user or the second test account of the user.

4. The method according to claim 1, wherein the purchaser view area includes a creating test order area, and the creating test order area is used to create one or more test orders for a selected test account of the user.

5. The method according to claim 4, the method further comprising:
receiving a request to create a test order from the creating test order area;
creating the test order for the user; and
sending the information of the test order to the user device to display information of the test order.

6. The method according to claim 5, wherein the purchaser view area further includes an order status action area, and the order status action area is used to change the order status of the test order by the user.

7. The method according to claim 6, the method further comprising:
receiving a request to change the order status of the test order from the order status action area; and
changing, based on the request to change the order status of the test order from the order status action area, the order status of the test order.

8. The method according to claim 7, wherein changing, based on the request to change the order status of the test order from the order status action area, the order status of the test order comprises:
providing candidate change options for change the order status for the user;
receiving the selected change option from the order status action area;
changing, based on the selected change option from the order status action area, the order status of the test order without verifying an actual status of the test order; and
sending the changed order status of the test order to the user device to display the changed order status.

9. The method according to claim 1, wherein the test page further includes a seller view area, and the seller view area includes a shipping management area, and the shipping management area is at least used to change a shipping status of a test order.

10. The method according to claim 9, the method further comprising:
receiving a request to change the shipping status of the test order from the shipping management area; and
changing, based on the request to change the shipping status of the test order from the shipping management area, the shipping status of the test order.

11. The method according to claim 10, wherein changing, based on the request to change the shipping status of the test order from the shipping management area, the shipping status of the test order comprises:
providing candidate change options for change the shipping status for the user;
receiving the selected change option from shipping management area;
changing, based on the selected change option from shipping management area, the shipping status of the test order without verifying an actual shipping status of the test order; and
sending the changed shipping status of the test order to the user device to display the changed shipping status.

12. The method according to claim 1, wherein the test account area includes a test account displaying area, and the purchaser view area further includes an order display area, and the order display area is for displaying information of one or more test orders of a selected test account of the user, and the information of the one or more test orders includes at least one of an order number and an order status.

13. The method according to claim 12, wherein the test page further includes a seller view area, and the seller view area includes a shipping status displaying area, and the shipping status display area is for displaying shipping information of one or more test orders of a selected test account of the user, and the shipping information of the one or more test orders includes at least one of an order number and a shipping status.

14. The method according to claim 13, the method further comprising at least one of the following:
sending the created test account to the user device to display the created test account in the test account displaying area of the test account area;
sending the information of one or more test orders of a selected test account of the user to the user device to display information of one or more test orders in the order display area of the seller view area; or
sending the shipping information of one or more test orders of a selected test account of the user to the user device to display the shipping information of one or more test orders in the shipping status display area of the seller view area.

15. The method according to claim 1, wherein the test page further includes a seller view area, and the test account area, the purchaser view area and the seller view area interact based on one or more test accounts.

16. The method according to claim 15, the method further comprising at least one of the following:
developing, based on JavaScript (JS) and Cascading Style Sheets (CSS), the test account area and the purchaser view area; or
developing, based on at least one of iframe, widget and dynokit, the seller view area, wherein a seller center core is inserted into the seller view area.

17. The method according to claim 15, wherein the test account area, the purchaser view area and the seller view area are all on the same page of the test page.

18. The method according to claim 15, wherein the sizes of the test account area, the purchaser view area and the seller view area are dynamically adjustable by the user.

19. An electronic device, comprising:
a memory and a processor;
wherein the memory is configured to store one or more computer instructions which, when executed by the processor, cause the processor to:
receive a test request to an application from a user device;
send a test page to the user device, wherein the test page is for the user to test the application, and the test page includes a test account area and a purchaser view area;
receive a first account request from the test account area; and
create, based on the first account request, the first test account for the user with verifying an identification and a password of the user.

20. A non-transitory computer-readable medium comprising instructions stored thereon which, when executed by a processor, cause the processor to:
receive a test request to an application from a user device;
send a test page to the user device, wherein the test page is for the user to test the application, and the test page includes a test account area and a purchaser view area;
receive a first account request from the test account area; and
create, based on the first account request, the first test account for the user with verifying an identification and a password of the user.
